(19) United States
(12) Patent Application Publication
(10) Pub. No.: US 2025/0016505 A1
(43) Pub. Date: Jan. 9, 2025

(54) ACOUSTIC MODULE AND ELECTRONIC DEVICE

(71) Applicant: VIVO MOBILE COMMUNICATION CO., LTD., Guangdong (CN)

(72) Inventors: Xinkun CHENG, Guangdong (CN); Zhiyuan WANG, Guangdong (CN)

(73) Assignee: VIVO MOBILE COMMUNICATION CO., LTD., Guangdong (CN)

(21) Appl. No.: 18/892,247

(22) Filed: Sep. 20, 2024

Related U.S. Application Data
(63) Continuation of application No. PCT/CN2023/082263, filed on Mar. 17, 2023.

(30) Foreign Application Priority Data
Mar. 21, 2022 (CN) 202210278521.8

(51) Int. Cl. H04R 9/02; H04R 7/20; H04R 9/04

(52) U.S. Cl. CPC H04R 9/025; H04R 7/20; H04R 9/045

(57) ABSTRACT

An acoustic module and an electronic device, the acoustic module including a housing, a magnet bowl, a central magnet, an edge magnet, a voice coil, a vibration diaphragm and a magnetic conductive assembly. The magnet bowl is arranged in the housing, the central magnet and the edge magnet are both arranged in the magnet bowl, the edge magnet is arranged on an outer side of the central magnet, a first gap is defined between the edge magnet and the central magnet, the vibration diaphragm is arranged in the housing and movably connected to the housing, and the voice coil is arranged on the vibration diaphragm and is opposite to the first gap. The magnetic conductive assembly is arranged on the voice coil, and includes a first magnetic conductive member and a second magnetic conductive member.

### CROSS-REFERENCE TO RELATED APPLICATIONS

This application is a continuation of International Application No. PCT/CN2023/082263 filed on Mar. 17, 2023, which claims priority to Chinese Patent Application No. 202210278521.8 filed on Mar. 21, 2022, which are incorporated herein by reference in their entireties.

### TECHNICAL FIELD

The present application pertains to the field of acoustic devices, and in particular to an acoustic module and an electronic device.

### BACKGROUND

Acoustic modules are provided in electronic devices, and electrical signals of the electronic devices are converted into sound signals by the acoustic modules to make a sound. With the increasing use of electronic devices, people's requirements for the performance of electronic devices are becoming higher. For example, music, video, games and calls of electronic devices all require the acoustic modules to have a better acoustic performance to improve user experience. Therefore, the requirements for the acoustic performance of the acoustic modules are also being increasing.

In acoustic modules, for example, loudspeakers, receivers or other acoustic modules, a magnetic field is formed by a magnet, and a voice coil is located in the magnetic field. When an alternating current is introduced into the voice coil, the voice coil reciprocates in the magnetic field, thereby driving a vibration diaphragm to move, and pushing air to make a sound. The magnetic field formed by the magnet is stronger in a region close to the magnet and weaker in a region away from the magnet. During the reciprocation of the voice coil, when the voice coil moves to a position away from the magnet, the magnetic field is weak, resulting in insufficient magnetic force, and consequently affecting the acoustic performance of the acoustic module.

### SUMMARY

An objective of embodiments of the present application is to provide an acoustic module and an electronic device.

In a first aspect, an embodiment of the present application provides an acoustic module including a housing, a magnet bowl, a central magnet, an edge magnet, a voice coil, a vibration diaphragm and a magnetic conductive assembly.

The magnet bowl is arranged in the housing, the central magnet and the edge magnet are both arranged in the magnet bowl, the edge magnet is arranged on an outer side of the central magnet, a first gap is defined between the edge magnet and the central magnet, the vibration diaphragm is arranged in the housing and movably connected to the housing, and the voice coil is arranged on the vibration diaphragm and is opposite to the first gap.

The magnetic conductive assembly is arranged on the voice coil, and includes a first magnetic conductive member and a second magnetic conductive member, the first magnetic conductive member being at least partially located on an edge of the voice coil close to the central magnet, and the second magnetic conductive member being at least partially located on an edge of the voice coil close to the edge magnet.

In a second aspect, an embodiment of the present application provides an electronic device including the acoustic module as described above.

### BRIEF DESCRIPTION OF THE DRAWINGS

FIG. 1 is a schematic structural diagram showing an acoustic module (a housing is not shown) according to an embodiment of the present application;

FIG. 2 is a schematic top view of a voice coil and a magnetic conductive assembly of an acoustic module according to an embodiment of the present application;

FIG. 3 is a schematic structural diagram showing a second magnetic conductive member of an acoustic module according to an embodiment of the present application;

FIG. 4 is a schematic diagram showing a magnetic field in a case that an acoustic module is not provided with a magnetic conductive assembly according to an embodiment of the present application;

FIG. 5 is a schematic diagram showing a magnetic field in a case that an acoustic module is provided with a magnetic conductive assembly according to an embodiment of the present application;

FIG. 6 is a schematic structural diagram showing an acoustic module (a housing is shown) according to an embodiment of the present application; and

FIG. 7 is an enlarged view of a portion of FIG. 1.

### DESCRIPTIONS OF REFERENCE NUMERALS

100—magnet bowl,
200—central magnet,
300—edge magnet,
400—voice coil,
510—first magnetic conductive member, 511—first side magnetic conductive portion, 512—first end magnetic conductive portion, 520—second magnetic conductive member, 521—second side magnetic conductive portion, 522—second end magnetic conductive portion, 530—third magnetic conductive member, 531—third side magnetic conductive portion, 532—third end magnetic conductive portion, 540—fourth magnetic conductive member, 541—fourth side magnetic conductive portion, 542—fourth end magnetic conductive portion, 550—second gap, 560—third gap, 600—first gap,
700—vibration diaphragm, 710—suspension,
800—magnetic conductive sheet,
910—bracket, 920—housing, and 930—sound outlet.

### DETAILED DESCRIPTION

The technical solutions in embodiments of the present application are clearly described in the following with reference to the accompanying drawings in the embodiments of the present application. Apparently, the described embodiments are merely some rather than all of the embodiments of the present application. All other embodiments obtained by persons skilled in the art based on the embodiments of the present application fall within the protection scope of the present application.

The specification and claims of the present application, and terms “first” and “second” are used to distinguish similar objects, but are unnecessarily used to describe a specific sequence or order. It will be appreciated that the data so used may be interchanged under appropriate circumstances such that embodiments of the present application may be practiced other than those illustrated or described herein, and that the words “first”, “second”, etc. do not necessarily distinguish one element from another, but rather denote any number of elements, e.g., a first element may be one or more than one. In addition, “and/or” in the specification and claims means at least one of connected objects, a character “/”, and generally means that the former and latter related objects are in an “or” relationship.

The following describes the acoustic module provided by the embodiments of the present application in detail through specific embodiments and application scenarios thereof with reference to the accompanying drawings.

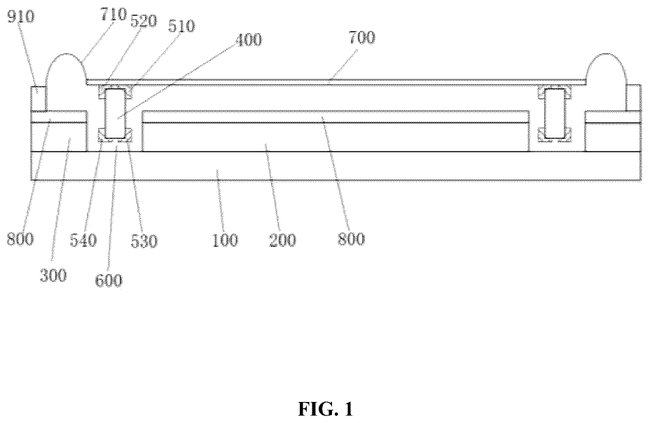

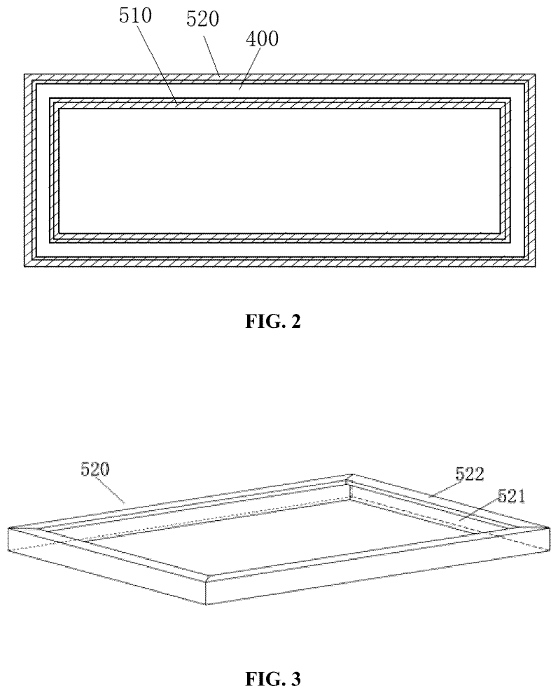

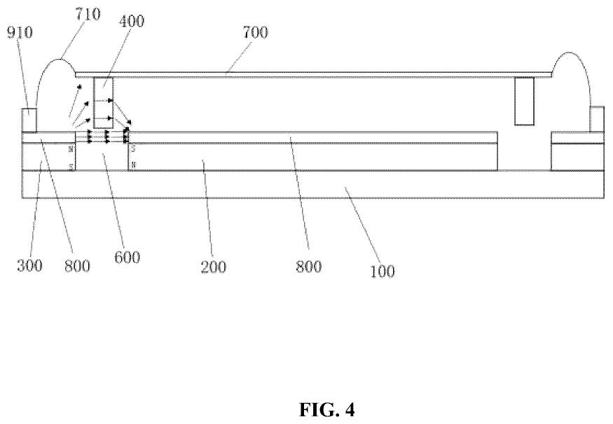

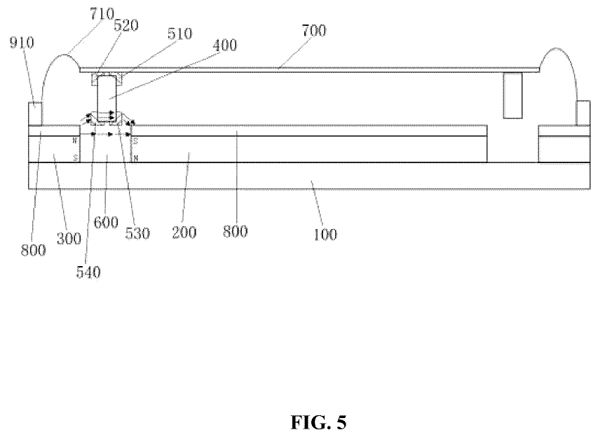

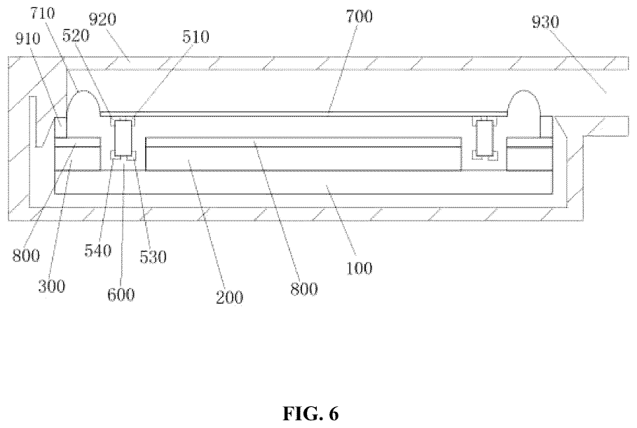

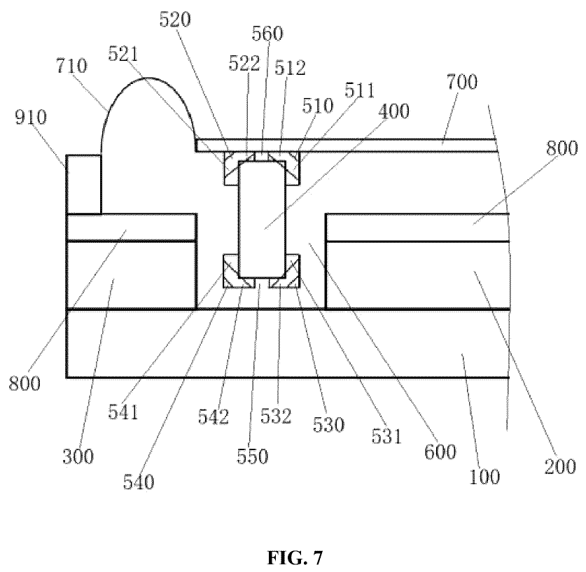

As shown in FIG. 1 to FIG. 7, an embodiment of the present application provides an acoustic module through which an electrical signal of an electronic device is converted into a sound signal to make a sound, the acoustic module including a housing 920, a magnet bowl 100, a central magnet 200, an edge magnet 300, a voice coil 400, a vibration diaphragm 700, and a magnetic conductive assembly.

The housing 920 is a body member of the acoustic module, and can provide a mounting base and a mounting space for other structural members of the acoustic module. The housing 920 can be a steel sheet or plastic housing 920. The housing 920 has an accommodating cavity. The other structural members of the acoustic module are provided in the accommodating cavity, for example, the magnet bowl 100, the central magnet 200, the edge magnet 300, the voice coil 400 and the vibration diaphragm 700 are all provided in the accommodating cavity of the housing 920.

The magnet bowl 100 is arranged within the housing 920, the central magnet 200 and the edge magnet 300 are both arranged in the magnet bowl 100, the magnet bowl 100 can provide support for the central magnet 200 and the edge magnet 300, and the magnet bowl 100 can also promote the formation of a magnetic field between the central magnet 200 and the edge magnet 300. The edge magnet 300 is arranged on an outer side of the central magnet 200, and a first gap 600 is defined between the edge magnet 300 and the central magnet 200. The magnet bowl 100, the central magnet 200, and the edge magnets 300 cooperate to form a magnetic field at and near the first gap 600.

The vibration diaphragm 700 is arranged in the housing 920, and the vibration diaphragm 700 is connected to the housing 920. The vibration diaphragm 700 can be elastically connected to the housing 920. When the vibration diaphragm 700 vibrates inside the accommodating cavity of the housing 920, the connection between the vibration diaphragm 700 and the housing 920 is not broken. For example, the vibration diaphragm 700 may be connected to the housing 920 by a resilient suspension 710. Alternatively, the vibration diaphragm 700 may be connected to the bracket 910 by a resilient suspension 710, the bracket 910 is connected to the housing 920, or the bracket 910 may be part of the housing 920.

The voice coil 400 is arranged on the vibration diaphragm 700. The voice coil 400 is opposite to the first gap 600 and can reciprocate in and out of the first gap 600. The central magnet 200 and the edge magnet 300 are cooperated at and near the first gap 600 to form a magnetic field. The voice coil 400 is located in the magnetic field. When an alternating current is introduced into the voice coil 400, the voice coil 400 can reciprocate in the magnetic field, and can reciprocate in and out of the first gap 600. The vibration diaphragm 700 connected to the voice coil 400 can be driven to move, and then the air between the vibration diaphragm 700 and the housing 920 is driven to vibrate to make a sound, and is transmitted out of the housing 920 through the sound outlet 930.

The magnetic conductive assembly is arranged on the voice coil 400, and includes a first magnetic conductive member 510 and a second magnetic conductive member 520. The first magnetic conductive member 510 is at least partially located on an edge of the voice coil 400 close to the central magnet 200, and the second magnetic conductive member 520 is at least partially located on an edge of the voice coil 400 close to the edge magnet 300. The first and second magnetic conductive members 510, 520 of the magnetic conductive assembly may guide a magnetic field to aggregate near the voice coil 400 to increase the magnetic field strength in the region of the voice coil 400, thereby increasing the magnetic force. Therefore, even if the voice coil 400 moves to a region where the magnetic field is weak, the magnetic field around the voice coil 400 can be aggregated near the voice coil 400 under the action of the magnetic conductive assembly, so that the magnetic force is increased, thereby increasing the sound volume, improving the sound quality, and improving the acoustic performance of the acoustic module.

In this embodiment of the present application, the voice coil 400 has a first end opposite the magnet bowl 100 and a second end facing away from the magnet bowl 100, and the first and the second magnetic conductive members 510, 520 are both arranged at the first end. The first end is an end of the voice coil 400 which is nearest to the magnet bowl 100. When the voice coil 400 moves away from the magnet bowl 100, the first end of the voice coil 400 gradually moves away from the magnet bowl 100, and gradually moves away from the magnetic field formed by the central magnet 200 and the edge magnet 300. When the first end moves to a region where the magnetic field is weak, the magnetic field strength passing through the voice coil 400 is weak, and in this case, the magnetic force received by the voice coil 400 is small. The first and the second magnetic conductive members 510, 520 are both arranged at the first end, and can guide the magnetic field to aggregate near the first end of the voice coil 400, to increase the magnetic field strength in a region where the first end of the voice coil 400 is located, thereby increasing the magnetic force. Therefore, even if the voice coil 400 moves to a region where the magnetic field is weak, the magnetic field around the voice coil 400 can be aggregated near the voice coil 400 under the action of the magnetic conductive assembly, so that the magnetic force is increased, thereby increasing the sound volume, improving the sound quality, and improving the acoustic performance of the acoustic module.

Specifically, the first magnetic conductive member 510 may include a first side magnetic conductive portion 511 and a first end magnetic conductive portion 512 connected to each other, and the second magnetic conductive member 520 includes a second side magnetic conductive portion 521 and a second end magnetic conductive portion 522 connected to each other. The first side magnetic conductive portion 511 is located on the edge of the voice coil 400 close to the central magnet 200, the second side magnetic conductive portion 521 is located on the edge of the voice coil 400 close to the edge magnet 300, the first and second end magnetic conductive portions 512, 522 are both located between a side of the first end facing the magnet bowl 100 and the magnet bowl 100, and the first and second end magnetic conductive portions 512, 522 define a second gap 550 therebetween.

The first and second side magnetic conductive portions 511, 521 cooperate to guide the magnetic field to aggregate near the voice coil 400 and pass through the voice coil 400, to increase the magnetic field strength in a region where the voice coil 400 is located, thereby increasing the magnetic force. The first and second end magnetic conductive portions 512, 522 may increase the contact area of the first and second magnetic conductive members 510, 520 with the voice coil 400, so that the first and second magnetic conductive members 510, 520 are more firmly connected to the voice coil 400, and the mounting of the first and second magnetic conductive members 510, 520 to the voice coil 400 is also facilitated. Moreover, the first and second end magnetic conductive portions 512, 522 are connected to the voice coil 400 at an end of the voice coil 400, and the first and second side magnetic conductive portions 511, 521 are prevented from relatively moving with the voice coil 400 in the moving direction of the voice coil 400 during the reciprocation of the voice coil 400, that is, the first and second side magnetic conductive portions 511, 521 are prevented from sliding with respect to the voice coil 400 under the action of inertia.

Furthermore, the second gap 550 between the first and second end magnetic conductive portions 512, 522 can prevent the first and second end magnetic conductive portions 512, 522 from being connected to each other, and the magnetic field cannot directly pass through the first and second end magnetic conductive portions 512, 522, but needs to pass through the voice coil 400, to aggregate the magnetic field near the voice coil 400 and increase the magnetic field strength in a region where the voice coil 400 is located.

In this embodiment of the present application, the magnetic conductive assembly further includes a third magnetic conductive member 530 and a fourth magnetic conductive member 540, the third magnetic conductive member 530 is at least partially located on the edge of the voice coil 400 close to the central magnet 200, the fourth magnetic conductive member 540 is at least partially located on the edge of the voice coil 400 close to the edge magnet 300, and the third and fourth magnetic conductive members 530, 540 are both arranged at the second end.

The second end is an end of the voice coil 400 which is farthest away from the magnet bowl 100. When the voice coil 400 moves away from the magnet bowl 100, the second end of the voice coil 400 gradually moves away from the magnet bowl 100, and gradually moves away from the magnetic field formed by the central magnet 200 and the edge magnet 300, and the second end first moves to a region where the magnetic field is weak. The third and fourth magnetic conductive members 530, 540 are both arranged at the second end, and can guide the magnetic field to aggregate near the second end of the voice coil 400, to increase the magnetic field strength in a region where the second end of the voice coil 400 is located, thereby increasing the magnetic force. Therefore, even if the voice coil 400 moves to a region where the magnetic field is weak, the magnetic field around the voice coil 400 can be aggregated near the voice coil 400 under the action of the magnetic conductive assembly, so that the magnetic force is increased, thereby increasing the sound volume, improving the sound quality, and improving the acoustic performance of the acoustic module.

In this embodiment of the present application, a first magnetic conductive member 510 and a second magnetic conductive member 520 may be provided at a first end, a third magnetic conductive member 530 and a fourth magnetic conductive member 540 may be provided at a second end, and a magnetic conductive assembly may be provided at both ends of the voice coil 400, so that the magnetic field around the voice coil 400 may be aggregated near the voice coil 400 as much as possible, so that the magnetic force is increased, thereby increasing the sound volume, improving the sound quality, and improving the acoustic performance of the acoustic module.

Specifically, the third magnetic conductive member 530 includes a third side magnetic conductive portion 531 and a third end magnetic conductive portion 532 connected to each other, and the fourth magnetic conductive member 540 includes a fourth side magnetic conductive portion 541 and a fourth end magnetic conductive portion 542 connected to each other, where the third side magnetic conductive portion 531 is located on the edge of the voice coil 400 close to the central magnet 200, the fourth side magnetic conductive portion 541 is located on the edge of the voice coil 400 close to the edge magnet 300, the third and fourth end magnetic conductive portions 532, 542 are both located on a side of the second end facing away from the magnet bowl 100, and a third gap 560 is defined between the third and fourth end magnetic conductive portions 532, 542.

The third side magnetic conductive portion 531 and the second side magnetic conductive portion 541 cooperate to guide the magnetic field to aggregate near the voice coil 400 and pass through the voice coil 400, to increase the magnetic field strength in a region where the voice coil 400 is located, thereby increasing the magnetic force. The third and fourth end magnetic conductive portions 532, 542 may increase the contact area of the third and fourth magnetic conductive members 530, 540 with the voice coil 400, so that the third and fourth magnetic conductive members 530, 540 are more firmly connected to the voice coil 400, and also facilitate the mounting of the third and fourth magnetic conductive members 530, 540 to the voice coil 400. Moreover, the third and fourth end magnetic conductive portions 532, 542 are connected to the voice coil 400 at an end of the voice coil 400, and the third and fourth side magnetic conductive portions 531, 541 are prevented from relatively moving with the voice coil 400 in the moving direction of the voice coil 400 during the reciprocation of the voice coil 400, that is, the third and fourth side magnetic conductive portions 531, 541 are prevented from sliding with respect to the voice coil 400 under the action of inertia.

Furthermore, the third gap 560 is defined between the third and fourth end magnetic conductive portions 532, 542, to avoid the connection between the third and fourth end magnetic conductive portions 532, 542, and the magnetic field cannot directly pass through the third and fourth end magnetic conductive portions 532, 542, but needs to pass through the voice coil 400, to aggregate the magnetic field near the voice coil 400 and increase the magnetic field strength in a region where the voice coil 400 is located.

The voice coil 400 can be directly connected to the vibration diaphragm 700, and the voice coil 400 moves in a magnetic field to drive the vibration diaphragm 700 to vibrate. In this embodiment of the present application, the voice coil 400 is connected to the vibration diaphragm 700 via a third and fourth magnetic conductive members 530, 540. Therefore, the third and fourth magnetic conductive members 530, 540 can function both to aggregate the magnetic field near the voice coil 400 to increase the magnetic field strength in a region where the voice coil 400 is located and to connect the voice coil 400 and the vibration diaphragm 700. Furthermore, the third and fourth magnetic conductive members 530, 540 are connected to the voice coil 400 on one side and the vibration diaphragm 700 on the other side, thereby further improving the connection reliability of the third and fourth magnetic conductive members 530, 540 on the voice coil 400.

In this embodiment of the present application, the first and the second magnetic conductive members 510, 520 are both annular members and are both arranged around the voice coil 400. As such, a magnetic conductive assembly is provided on the whole annular periphery of the voice coil 400 to aggregate the magnetic field near the voice coil 400, to increase the magnetic field strength in a region where the voice coil 400 is located. Moreover, the first and second magnetic conductive members 510, 520 are directly sleeved outside or inside the voice coil 400 to facilitate mounting of the first and second magnetic conductive members 510, 520.

Alternatively, the first and second magnetic conductive members 510, 520 may be adhered to the voice coil 400 by glue or the like.

The third and fourth magnetic conductive members 530, 540 are both annular members and are both arranged around the voice coil 400. As such, a magnetic conductive assembly is provided on the whole annular periphery of the voice coil 400 to aggregate the magnetic field near the voice coil 400, to increase the magnetic field strength in a region where the voice coil 400 is located. Moreover, the third and fourth magnetic conductive members 530, 540 are directly sleeved outside or inside the voice coil 400 to facilitate mounting of the third and fourth magnetic conductive members 530, 540.

Alternatively, the third and fourth magnetic conductive members 530, 540 may be adhered to the voice coil 400 by glue or the like.

In this embodiment of the present application, the acoustic module further includes a magnetic conductive sheet 800 arranged on the central magnet 200 and the edge magnet 300, and the magnetic conductive sheet is located on a side of the central magnet 200 and the edge magnet 300 facing away from the magnet bowl 100. The magnetic conductive sheet 800 has a good magnetic conductive property so that the magnetic field formed between the central magnetic field and the edge magnet 300 can be guided to a large extent to pass through the voice coil 400. Furthermore, the magnetic conductive sheet 800, the central magnet 200, the edge magnets 300, and the magnet bowl 100 may facilitate the formation of a closed magnetic field.

The acoustic module in this embodiment of the present application can be a loudspeaker, a receiver, etc. but can also be other acoustic modules.

An embodiment of the present application also provides an electronic device including the acoustic module as described above. An acoustic module is characterized in that it includes a housing 920, a magnet bowl 100, a central magnet 200, an edge magnet 300, a voice coil 400, a vibration diaphragm 700 and a magnetic conductive assembly. The magnet bowl 100 is arranged in the housing 920, the central magnet 200 and the edge magnet 300 are both arranged in the magnet bowl 100, the edge magnet 300 is arranged on an outer side of the central magnet 200, a first gap 600 is defined between the edge magnet 300 and the central magnet 200, the vibration diaphragm 700 is arranged in the housing 920, the vibration diaphragm 700 is connected to the housing 920, the voice coil 400 is arranged on the vibration diaphragm 700, and the voice coil 400 is opposite to the first gap 600 and can reciprocate in and out of the first gap 600. The magnetic conductive assembly is arranged on the voice coil 400, and includes a first magnetic conductive member 510 and a second magnetic conductive member 520. The first magnetic conductive member 510 is at least partially located on the edge of the voice coil 400 close to the central magnet 200, and the second magnetic conductive member 520 is at least partially located on the edge of the voice coil 400 close to the edge magnet 300.

The magnet bowl 100, the central magnet 200 and the edge magnet 300 cooperate to form a magnetic field. The voice coil 400 is located in the magnetic field. When an alternating current is introduced into the voice coil 400, the voice coil 400 can reciprocate in the magnetic field, thereby driving the vibration diaphragm 700 connected to the voice coil 400 to move, and pushing the air to make a sound. The magnetic conductive assembly is provided on the voice coil 400. The first and the second magnetic conductive members 510, 520 of the magnetic conductive assembly can guide the magnetic field to aggregate near the voice coil 400, to increase the magnetic field strength in a region where the voice coil 400 is located, thereby increasing the magnetic force. Therefore, even if the voice coil 400 moves to a region where the magnetic field is weak, the magnetic field around the voice coil 400 can be aggregated near the voice coil 400 under the action of the magnetic conductive assembly, so that the magnetic force is increased, thereby increasing the sound volume, improving the sound quality, and improving the acoustic performance of the acoustic module.

The electronic device disclosed in this embodiment of the present application may be a smart phone, a tablet computer, an electronic book reader, or a wearable device. Of course, the electronic device may be other devices, and this embodiment of the present application are not limited thereto.

It should be noted that the terms “include”, “comprise”, or any other variation thereof in this specification are intended to cover a non-exclusive inclusion, such that processes, methods, objects, or apparatuses that include a list of elements does not include only those elements but may include other elements not expressly listed or inherent to such processes, methods, objects, or apparatuses. Without more limitations, elements defined by the sentence “including one . . . ” does not exclude that there are still other same elements in the processes, methods, objects, or apparatuses.

The embodiments of the present application have been described above with reference to the accompanying drawings. However, the present application is not limited to the specific embodiments described above, and the specific embodiments described above are merely exemplary and not limitative. A person skilled in the art may make various variations under the teaching of the present application without departing from the spirit of the present application and the protection scope of the claims, and such variations shall all fall within the protection scope of the present application.

What is claimed is:

1. An acoustic module, comprising a housing, a magnet bowl, a central magnet, an edge magnet, a voice coil, a vibration diaphragm and a magnetic conductive assembly,
the magnet bowl being arranged in the housing, the central magnet and the edge magnet being both arranged in the magnet bowl, the edge magnet being arranged on an outer side of the central magnet, a first gap being defined between the edge magnet and the central magnet, the vibration diaphragm being arranged in the housing and connected to the housing, and the voice coil being arranged on the vibration diaphragm and being opposite to the first gap; and
the magnetic conductive assembly being arranged on the voice coil, and comprising a first magnetic conductive member and a second magnetic conductive member, the first magnetic conductive member being at least partially located on an edge of the voice coil close to the central magnet, and the second magnetic conductive member being at least partially located on an edge of the voice coil close to the edge magnet.

2. The acoustic module according to claim 1, wherein the voice coil has a first end opposite the magnet bowl and a second end facing away from the magnet bowl, the first and second magnetic conductive members being both arranged at the first end.

3. The acoustic module according to claim 2, wherein the first magnetic conductive member comprises a first side magnetic conductive portion and a first end magnetic conductive portion connected to each other, the second magnetic conductive member comprises a second side magnetic conductive portion and a second end magnetic conductive portion connected to each other, the first side magnetic conductive portion is located on the edge of the voice coil close to the central magnet, the second side magnetic conductive portion is located on the edge of the voice coil close to the edge magnet, the first end magnetic conductive portion and the second end magnetic conductive portion are both located between a side of the first end facing the magnet bowl and the magnet bowl, and the first end magnetic conductive portion and the second end magnetic conductive portion define a second gap therebetween.

4. The acoustic module according to claim 2, wherein the magnetic conductive assembly further comprises a third magnetic conductive member and a fourth magnetic conductive member, the third magnetic conductive member being at least partially located on the edge of the voice coil close to the central magnet, the fourth magnetic conductive member being at least partially located on the edge of the voice coil close to the edge magnet, and the third and fourth magnetic conductive members being both arranged at the second end.

5. The acoustic module according to claim 4, wherein the third magnetic conductive member comprises a third side magnetic conductive portion and a third end magnetic conductive portion connected to each other, the fourth magnetic conductive member comprises a fourth side magnetic conductive portion and a fourth end magnetic conductive portion connected to each other, the third side magnetic conductive portion being located on the edge of the voice coil close to the central magnet, the fourth side magnetic conductive portion being located on the edge of the voice coil close to the edge magnet, the third end magnetic conductive portion and the fourth end magnetic conductive portion are both located on a side of the second end facing away from the magnet bowl, and the third end magnetic conductive portion and the fourth end magnetic conductive portion define a third gap therebetween.

6. The acoustic module according to claim 4, wherein the voice coil is connected to the vibration diaphragm via the third and fourth magnetic conductive members.

7. The acoustic module according to claim 1, wherein the first and second magnetic conductive members are both annular members and are both arranged around the voice coil.

8. The acoustic module according to claim 4, wherein the third and fourth magnetic conductive members are both annular members and are both arranged around the voice coil.

9. The acoustic module according to claim 1, wherein the acoustic module further comprises a magnetic conductive sheet arranged on the central magnet and the edge magnet, and the magnetic conductive sheet is located on a side of the central magnet and the edge magnet facing away from the magnet bowl.

10. An electronic device, comprising an acoustic module, wherein the acoustic module comprises a housing, a magnet bowl, a central magnet, an edge magnet, a voice coil, a vibration diaphragm and a magnetic conductive assembly,
the magnet bowl being arranged in the housing, the central magnet and the edge magnet being both arranged in the magnet bowl, the edge magnet being arranged on an outer side of the central magnet, a first gap being defined between the edge magnet and the central magnet, the vibration diaphragm being arranged in the housing and connected to the housing, and the voice coil being arranged on the vibration diaphragm and being opposite to the first gap; and
the magnetic conductive assembly being arranged on the voice coil, and comprising a first magnetic conductive member and a second magnetic conductive member, the first magnetic conductive member being at least partially located on an edge of the voice coil close to the central magnet, and the second magnetic conductive member being at least partially located on an edge of the voice coil close to the edge magnet.

11. The electronic device according to claim 10, wherein the voice coil has a first end opposite the magnet bowl and a second end facing away from the magnet bowl, the first and second magnetic conductive members being both arranged at the first end.

12. The electronic device according to claim 11, wherein the first magnetic conductive member comprises a first side magnetic conductive portion and a first end magnetic conductive portion connected to each other, the second magnetic conductive member comprises a second side magnetic conductive portion and a second end magnetic conductive portion connected to each other, the first side magnetic conductive portion is located on the edge of the voice coil close to the central magnet, the second side magnetic conductive portion is located on the edge of the voice coil close to the edge magnet, the first end magnetic conductive portion and the second end magnetic conductive portion are both located between a side of the first end facing the magnet bowl and the magnet bowl, and the first end magnetic conductive portion and the second end magnetic conductive portion define a second gap therebetween.

13. The electronic device according to claim 11, wherein the magnetic conductive assembly further comprises a third magnetic conductive member and a fourth magnetic conductive member, the third magnetic conductive member being at least partially located on the edge of the voice coil close to the central magnet, the fourth magnetic conductive member being at least partially located on the edge of the voice coil close to the edge magnet, and the third and fourth magnetic conductive members being both arranged at the second end.

14. The electronic device according to claim 13, wherein the third magnetic conductive member comprises a third side magnetic conductive portion and a third end magnetic conductive portion connected to each other, the fourth magnetic conductive member comprises a fourth side magnetic conductive portion and a fourth end magnetic conductive portion connected to each other, the third side magnetic conductive portion being located on the edge of the voice coil close to the central magnet, the fourth side magnetic conductive portion being located on the edge of the voice coil close to the edge magnet, the third end magnetic conductive portion and the fourth end magnetic conductive portion are both located on a side of the second end facing away from the magnet bowl, and the third end magnetic conductive portion and the fourth end magnetic conductive portion define a third gap therebetween.

15. The electronic device according to claim 13, wherein the voice coil is connected to the vibration diaphragm via the third and fourth magnetic conductive members.

16. The electronic device according to claim 10, wherein the first and second magnetic conductive members are both annular members and are both arranged around the voice coil.

17. The electronic device according to claim 13, wherein the third and fourth magnetic conductive members are both annular members and are both arranged around the voice coil.

18. The electronic device according to claim 10, wherein the acoustic module further comprises a magnetic conductive sheet arranged on the central magnet and the edge magnet, and the magnetic conductive sheet is located on a side of the central magnet and the edge magnet facing away from the magnet bowl.
